(19) United States
(12) Patent Application Publication
(10) Pub. No.: US 2008/0115661 A1
(43) Pub. Date: May 22, 2008

(54) Hydraulic system for supplying a hydraulic fluid to a component

(75) Inventors: Martin Staudinger, Ettlingen (DE); Eric Muller, Kaiserslautern (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/901,251

(22) Filed: Sep. 14, 2007

Related U.S. Application Data
(60) Provisional application No. 60/845,054, filed on Sep. 15, 2006.

(30) Foreign Application Priority Data
Sep. 14, 2006 (DE) 10 2006 043 077.8

(51) Int. Cl. F15B 13/04

(52) U.S. Cl. 91/418

(57) ABSTRACT

A hydraulic system for supplying a hydraulic fluid to a hydraulically-operated component. A pump for delivering component the hydraulic fluid from a reservoir is connected with the reservoir through a flow control valve. The control valve is a 4/3 directional flow control valve, in which two valve outlet connections are connected to a suction side of the pump and two valve inlet connections are connected to the reservoir. A flow restriction is positioned in each of the conduits extending from the reservoir to the valve inlet connections for reducing the energy consumption of the pump when the need for hydraulic fluid is low.

### BACKGROUND OF THE INVENTION

1. Field of the Invention

The present invention relates to a hydraulic system for supplying a hydraulic fluid to a component, as well as to a control valve for use in such a hydraulic system.

2. Description of the Related Art

Suction-throttled oil pumps for wet clutches, specifically for dual clutches, are known from DE 10 2005 027 610 A1, for example. Those are suction-throttled pumps that can serve at least two, and in most cases three, different cooling oil needs of the wet clutch. That necessitates a valve function, which is preferably integrated onto or into the pump. The need for cooling oil during driving operation is covered with a valve position, preferably a basic valve position brought about by a spring. That need is small in comparison to the active cooling needed when accelerating the vehicle from a stop and when shifting the transmission. For active cooling when driving off and when shifting, a different valve position is used in which the cooling oil is conducted to the wet clutch without throttling. In a third valve position the flow of the cooling oil is interrupted when synchronizing the partial transmissions in parallel shift transmissions, so that no cooling oil reaches the clutch or clutches.

A hydraulic system is known from DE 197 08 597 C1, in which the cooling oil requirement of a component is controlled by means of a pressure relief valve, whose control piston is connected to the pressure side of the pump.

A disadvantage of known solutions is high energy consumption by the pump, even when, and specifically when, the need for cooling oil is small. An object of the present invention is therefore to provide a hydraulic system and a control valve for it that reduce the energy need of the pump when the need for cooling oil is small.

### SUMMARY OF THE INVENTION

The object is achieved by a hydraulic system for supplying a hydraulic fluid, in particular a cooling and lubricating agent such as a hydraulic oil or cooling oil, to a component, in particular a wet clutch. A pump conveys the hydraulic fluid from a reservoir through a control valve to the component, the control valve being a 4/directional valve (meaning that the control valve has four connections). Two connections are connected to a suction side of the pump and two connections are connected to the reservoir. Being connected here means both a direct connection and a connection in which additional hydraulic components, such as filters, coolers, or the like are interposed. The hydraulic fluid is referred to hereinafter simply as oil. The control valve is preferably operated electromechanically, especially preferably by a proportional magnet. There is preferably a provision that the control valve is a 4/3 directional valve, so that the control valve has four connections and three valve positions. The control valve is an electromagnetically operated valve that can assume at least three different designated positions: one position for supplying a minimum quantity of oil, which is present even if the electrical power fails; one position for completely closing the intake port; and one position with maximum flow for conveying the maximum quantity of cooling oil.

The control valve preferably has a first valve position in which a valve outlet connection that is in communication with the suction side of the pump is also in communication with a valve inlet connection that is connected to the reservoir. A first flow restriction is preferably situated at the connection that is connected to the suction side of the pump in the first valve position.

There is preferably a provision that the control valve has a second valve position in which all connections are blocked. It is also preferably provided that the control valve includes a third valve position in which a connection that is in communication with the suction side of the pump is also in communication with a connection that is connected to the reservoir. The third valve position can preferably be adjusted continuously, in the manner of a proportional valve. There is preferably a provision that a flow restriction is situated at each of the connections that are connected with the suction side of the pump when the valve is in the third position. The minimum flow volume, i.e., the flow volume in the first valve position, can be set with one restriction, through which oil flows in the first valve position. To that end, the flow restriction must be designed appropriately with regard to its pressure loss. With the second flow restriction it is possible to set the maximum flow volume, the flow volume in the third valve position. To that end, the additional flow restriction through which oil flows in this valve position must be designed appropriately with regard to its pressure loss.

An advantage of the control valve with a suction restriction is that the pump consumes less energy when the control valve interrupts the supply stream. A conventional solution conveys the entire flow volume against a certain pressure level even when the need for cooling oil is small. With suction throttling, only the amount of oil that is actually employed is brought to pressure.

Since the valve is actuated electromagnetically, only relatively short travel distances are available for the valve spool. The maximum flow volume transported is very high, however. Since the control valve is located at the intake section of the pump (on the suction side), there are no large pressure differentials present that could enable a greater oil flow. In accordance with the invention, the supply channel of the valve is divided into two channels. That makes it possible to utilize the maximum flow per control edge, i.e., to transport about twice the quantity of oil in total. Furthermore, a specially designed restrictor can be integrated into each supply channel as a restriction. Hence a defined quantity of oil can be transported, depending upon whether one channel or both channels are opened.

The problem identified earlier is also solved by a control valve for use in a hydraulic system in accordance with one of the preceding claims.

### BRIEF DESCRIPTION OF THE DRAWINGS

The structure, operation, and advantages of the present invention will become further apparent upon consideration of the following description, taken in conjunction with the accompanying drawings in which:

FIG. 1 is a schematic diagram of a first exemplary embodiment of a hydraulic system in accordance with the invention for supplying oil to a wet clutch;

FIG. 2 is a cross-sectional view through a control valve in accordance with the invention when in a first operating position of the valve;

FIG. 3 is a cross-sectional view through a control valve in accordance with the invention when in a second operating position of the valve;

FIG. 4 is a cross-sectional view through a control valve in accordance with the invention when in a third operating position of the valve.

### DESCRIPTION OF THE PREFERRED EMBODIMENTS

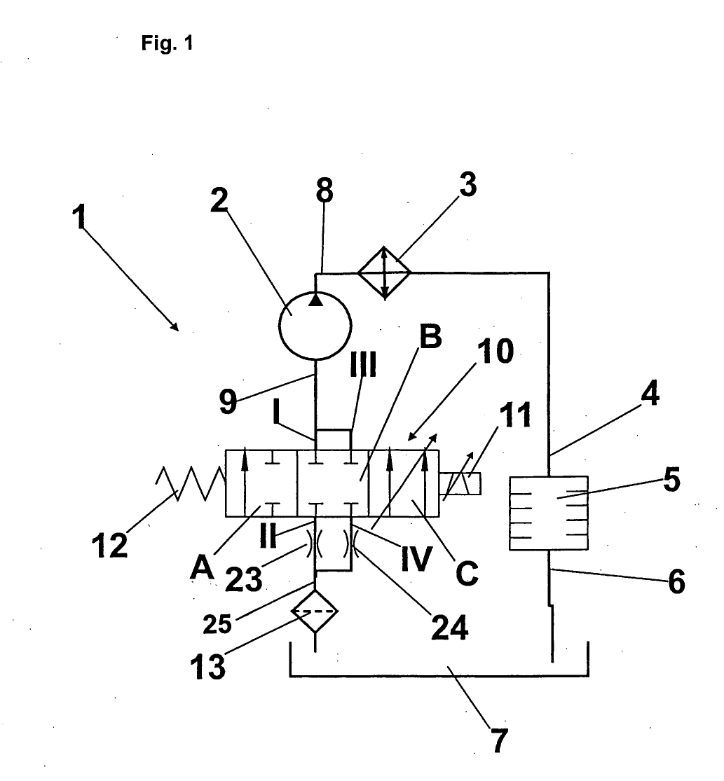

FIG. 1 is a hydraulic circuit diagram of an exemplary embodiment of a hydraulic system 1 in accordance with the invention. The representation of the control valve 10 corresponds to the customary manner of representation in DIN ISO 1219, in which a valve as such is represented by a rectangle, individual valve positions are represented by squares, connections and hydraulic lines are lines extending from the valves, couplings of the valve connections with each other are represented by arrows within the individual valve positions, blocked connections are represented by a “T.” and a flow restriction is represented by two oppositely-curved lines adjacent to a hydraulic line.

The hydraulic system 1 includes an electrically driven pump 2, which delivers hydraulic fluid (also referred to below as hydraulic oil, or “oil” for short) through an oil cooler 3 to an oil inlet 4 of a wet clutch 5. From wet clutch 5 the oil used for cooling and lubricating purposes is returned to a reservoir 7 through an oil outlet 6. Pump 2 has its pressure side 8 connected to oil cooler 3, and its suction side 9 is connected to control valve 10, which, in turn, is connected through an oil filter 13 to reservoir 7. Control valve 10 includes four fluid connections, two inlets and two outlets, and has three valve positions, which makes it a 4/3 directional valve. It is operated by a proportional magnet 11 as actuator, and is pressed by a spring 12 into one of the valve positions, here the first valve position A.

Control valve 10 includes three valve positions, which are designated in FIG. 1 as A, B, and C. Control valve 10 includes four connections, connections I and III which are each connected to suction side 9 of pump 8, and connections II and IV, which are each connected to reservoir 7 through oil filter 13. A first flow restriction 23 is situated at connection II, and a second flow restriction 24 is situated at connection IV.

In valve position A connection II is joined with connection I through first flow restriction 23; the entire volumetric flow passes through first flow restriction 23. Connections III and IV are blocked. In the middle valve position B all connections I through IV are blocked. In valve position C connection II is joined with connection I and connection IV is joined with connection III. Thus, in valve position C the entire volumetric flow flows in parallel through flow restrictions 23 and 24. Positions A and B are setting positions of control valve 10; valve position C is a proportional position, so that it has any number of intermediate positions. The property of a proportional valve in valve position C of control valve 10 is represented by an arrow through valve position C.

Control valve 10 is pressed into valve position A by spring 12, so that control valve 10 is in valve position A when no current is flowing through proportional magnet 11. By applying current to proportional magnet 11 a valve spool 14 of control valve 10 is pressed against the force of spring 12 into valve positions B or C. In valve position A, a constant minimum flow through control valve 10 takes place, which is determined by the restriction effect of first flow restriction 23. In valve position B no hydraulic fluid flows through control valve 10 to pump 2, while in valve position C the flow can be controlled between a minimum value of zero, which corresponds to valve position B, and a maximum value which is determined by flow restrictions 23 and 24.

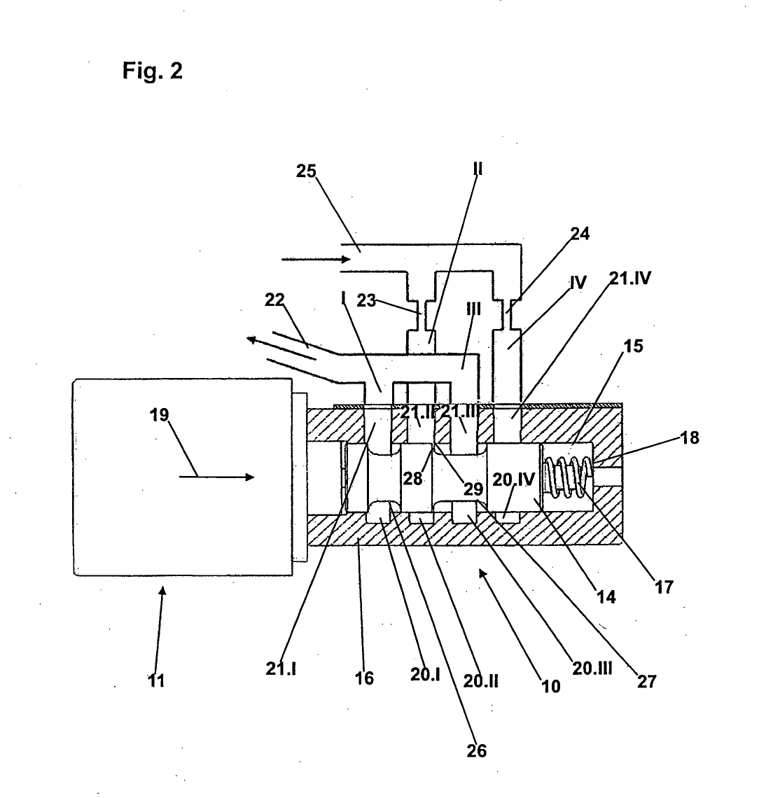

An exemplary embodiment of a control valve 10 in accordance with the invention will be shown in various valve positions in FIGS. 2 through 4. The basic construction of control valve 10 will first be explained with reference to FIG. 2.

FIG. 2 shows a section through a control valve 10 in accordance with the invention, with flange mounted proportional magnet 11. Proportional magnet 11 actuates a valve spool 14, which is movably situated in a bore 15 in a valve housing 16. Both bore 15 and valve spool 14 are substantially rotationally symmetrical. On its side facing away from proportional magnet 11, valve spool 14 includes a cylindrical region 17 with a diameter that is significantly smaller than the diameter of the rest of valve spool 14. Cylindrical region 17 carries a spring 18, which presses valve spool 14 in the direction of proportional magnet 11. Proportional magnet 11 includes a movable plunger (not shown) actuated by applying electrical current to the magnet. The plunger presses valve spool 14 in the direction toward spring 18 when electric current is applied. FIG. 2 shows the position of valve spool 14 when no current is applied to proportional magnet 11; when current is applied to proportional magnet 11, valve spool 14 is pressed in the direction of arrow 19. The force of spring 18 operates opposite to the direction of arrow 19.

Grooves 20.I, 20.II, 20.III, and 20.IV are formed in valve housing 16. The grooves are connected with supply channels 21.I, 21.II, 21.III, and 21.IV, respectively. The designations .I through IV stand for connections I through IV shown in FIG. 1. Groove 20.I together with supply channel 21.I forms connection I. Groove 20.II together with supply channel 21.II forms connection II. Groove 20.III together with supply channel 21.III forms connection III. Groove 20.IV together with supply channel 21.IV forms connection IV. Connections I and III lead to a common pump suction-side conduit 22, which is connected to the suction side 9 of pump 2. Connection II has a first flow restriction 23 and connection IV has a second flow restriction 24. Connections II and IV are combined into a reservoir conduit 25. Conduit 25 is connected to oil filter 13, and the latter, in turn, is connected to reservoir 7.

Valve spool 14 includes a first spool groove 26 and a second spool groove 27. The two spool grooves 26, 27 are both annular grooves. In valve position A shown in FIG. 2, second spool groove 27 connects annular grooves 20.II and 20.III, and thereby the supply channels 21.II and 21.III, so that a connection exists between connection II and connection I as a result of a gap or open space between control edge 28 of valve spool 14 and groove edge 29 of groove 20.II. In valve position A indicated in FIG. 2, connections I and IV are blocked.

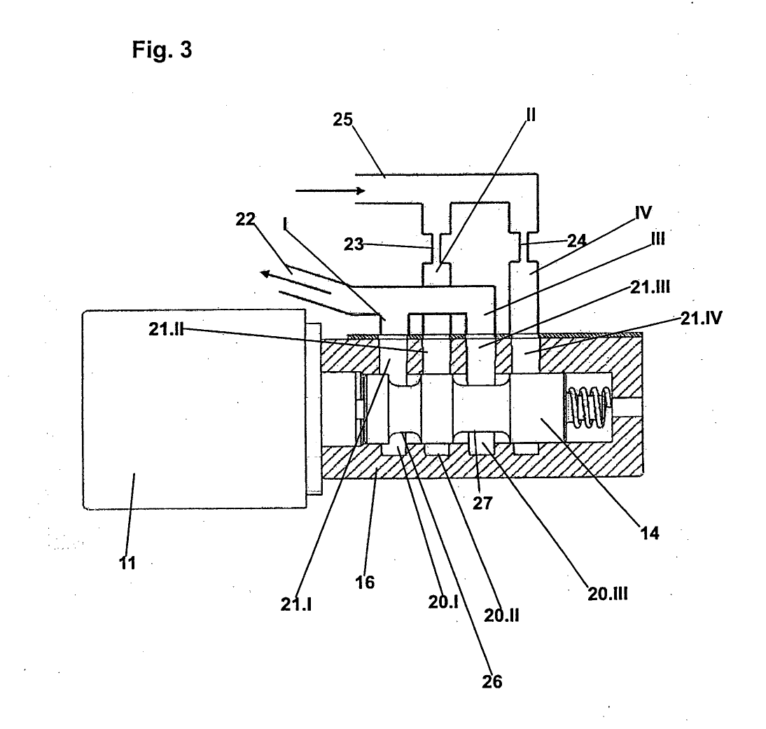

FIG. 3 shows valve position B indicated in FIG. 1. None of annular grooves 20.I, 20.II, 20.III and 20.IV are connected with each other via first spool groove 26 or second spool groove 27, so that each of connections I, II, III, and IV is blocked.

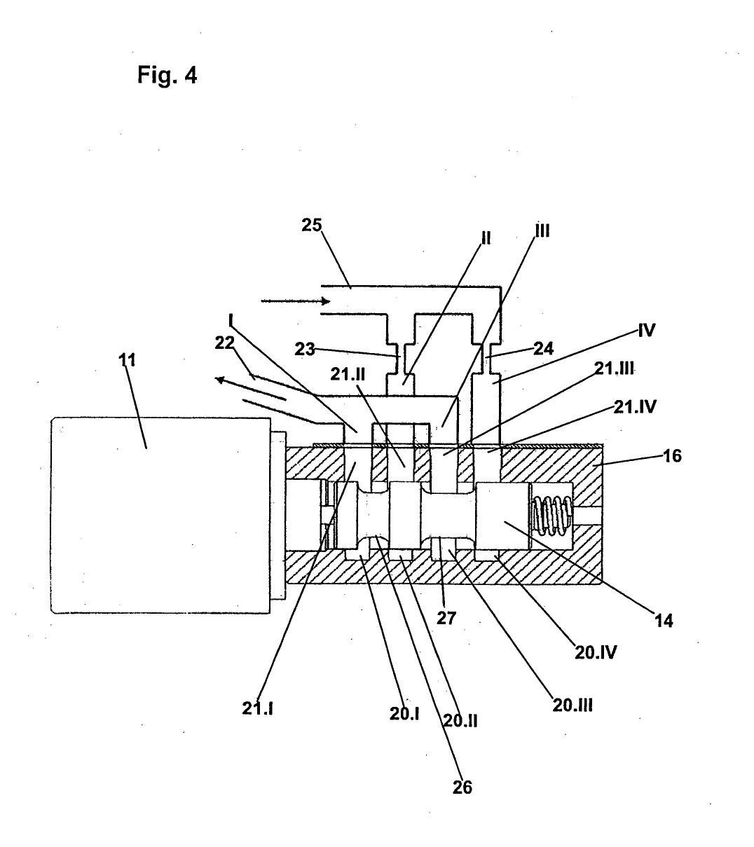

FIG. 4 shows valve position C indicated in FIG. 1. First spool groove 26 connects annular grooves 20.I and 20.II, and hence supply channels 21.I and 21.II; second spool groove 27 connects annular grooves 20.III and 20.IV, and hence supply channels 21.III and 21.IV. The passage cross sections formed between the spool grooves 20, 27 and the respective annular grooves 20.I, 20.II, 20.III, or 20.IV are configured so that they restriction the flow volume as little as possible.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A hydraulic system for supplying a hydraulic fluid to a component, said hydraulic system comprising: a pump for delivering hydraulic fluid from a reservoir; a control valve positioned between and connected with each of the pump and a hydraulically-operated component; wherein the control valve is a four-connection directional flow control valve having first and second valve outlet connections that are each connected to a suction side of the pump, and having first and second valve inlet connections connected to the reservoir.

2. A hydraulic system in accordance with claim 1, wherein the control valve is operated electromechanically.

3. A hydraulic system in accordance with claim 2, wherein the control valve is operated electromechanically by a proportional magnet.

4. A hydraulic system in accordance with claim 1, wherein the control valve is a ¾ directional valve.

5. A hydraulic system in accordance with claim 4, wherein the control valve has a first valve position in which the first valve outlet connection that is connected to the suction side of the pump communicates with the first valve inlet connection that is connected to the reservoir.

6. A hydraulic system in accordance with claim 5, including a first flow restriction positioned in a conduit extending between the first valve inlet connection that is in communication with the suction side of the pump, and the reservoir when the valve is in a first valve operating position.

7. A hydraulic system in accordance with claim 1, wherein the control valve includes a second valve operating position in which all valve inlet and all valve outlet connections are blocked.

8. A hydraulic system in accordance with claim 1, wherein the control valve includes a third valve operating position in which one of the first and second valve outlet connections that is connected to the suction side of the pump is in communication with a valve inlet connection that is connected to the reservoir.

9. A hydraulic system in accordance with claim 8, wherein the third valve operating position is continuously adjustable, after the manner of a proportional valve.

10. A hydraulic system in accordance with claim 9, wherein in the third valve operating position a flow restriction is situated in each conduit that extends from a valve inlet connection that is in communication with the suction side of the pump.

11. A control valve for use in a hydraulic system in accordance with claim 1.
